(19) United States
(12) Patent Application Publication
(10) Pub. No.: US 2025/0031167 A1
(43) Pub. Date: Jan. 23, 2025

(54) METHODS AND SYSTEMS FOR HANDLING NETWORK SLICE SUPPORT INFORMATION

(71) Applicant: SAMSUNG ELECTRONICS CO., LTD., Suwon-si (KR)

(72) Inventors: Lalith KUMAR, Bangalore (IN); Koustav ROY, Bangalore (IN); Jagadeesh GANDIKOTA, Bangalore (IN); Danish Ehsan HASHMI, Bangalore (IN); Krishnamurthy D R, Bangalore (IN); Ashok Kumar NAYAK, Bangalore (IN)

(21) Appl. No.: 18/777,402

(22) Filed: Jul. 18, 2024

(30) Foreign Application Priority Data
Jul. 21, 2023 (IN) 202341049450
Jul. 21, 2023 (IN) 202341049451
Jul. 9, 2024 (IN) 202341049450

(51) Int. Cl. H04W 60/00; H04W 24/02

(52) U.S. Cl. CPC H04W 60/00; H04W 24/02

(57) ABSTRACT

The disclosure relates to a 5G or 6G communication system for supporting a higher data transmission rate. Embodiments disclosed herein relate to methods and systems for updating a partially allowed network slice selection assistance information (NSSAI) list, and managing a congestion timer/back-off timer for an alternative single-NSSAI (S-NSSAI) in wireless communication networks. The methods include removing network slice support information stored in a user equipment (UE), if a Non-Access Stratum (NAS) message from a network indicates to delete the network slice support information. The methods include applying a back-off timer to the S-NSSAI to be replaced (S-NSSAI-1)/alternative S-NSSAI (S-NSSAI-A)/combination of S-NSSAI-A+S-NSSAI-1, on receiving a Packet Data Unit (PDU) session establishment request, when the network is congested. The methods include applying a back-off timer to the S-NSSAI-A/S-NSSAI-1/combination of S-NSSAI-A+S-NSSAI-1, on receiving a congestion timer from the network function while requesting an alternative S-NSSAI

### CROSS REFERENCE TO RELATED APPLICATION

This application is based on and claims priority under 35 U.S.C. § 119 to Indian Provisional Application No. 202341049450 filed on Jul. 21, 2023, and Indian Provisional Application No. 202341049451 filed on Jul. 21, 2023, and Indian Complete application No. 202341049450 filed on Jul. 9, 2024, in the Indian Intellectual Property Office, the disclosure of which are incorporated by reference herein in their entirety.

### BACKGROUND

### 1. Field

Embodiments disclosed herein relate to wireless communication networks, and more particularly to updating a partially allowed network slice selection assistance information (NSSAI) list, and managing a congestion timer/back-off timer for an alternative single-NSSAI (S-NSSAI) in wireless communication networks.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In general, partially allowed network slice selection assistance information (NSSAI) indicates single-NSSAIs (S-NSSAI) values where a user equipment (UE) could use in a serving public land mobile network (PLMN) or standalone non-public network (SNPN) in some of the tracking areas (TAs) in a current registration area (RA). Each S-NSSAI in the partially allowed NSSAI is associated with a list of TAs where the S-NSSAI is supported. If received, an S-NSSAI rejected partially in the RA may be stored in the UE while registration management (RM)-REGISTERED until the UE moves out of the current registration area or until the S-NSSAI is deleted.

A network slice may be supported in one or more TAs in a PLMN/SNPN. The partial network slice support in a registration area for a UE includes configuring the UE with a partially allowed NSSAI and/or S-NSSAI(s) rejected partially in the RA. When creating a registration area for UEs registering over a 3rd generation partnership project (3GPP) access, and supporting the partial network slice support in a registration area, the access and mobility management function (AMF) may consider the trade-off between signalling for paging in TAs where the S-NSSAI is not supported versus the signalling for mobility registration updates to register with the S-NSSAI in the TA(s) where the S-NSSAI is supported, so that the AMF may create a registration area including the TA(s) where a requested S-NSSAI is not supported.

Whether the AMF for supporting UEs uses the partially allowed NSSAI or rejects the S-NSSAIs partially in the RA is a per S-NSSAI decision which is based on AMF local policy. If supported and allowed by local policy, the partially allowed NSSAI and S-NSSAIs rejected partially in the RA may be applied simultaneously for one UE for different S-NSSAIs.

While the S-NSSAIs of the allowed NSSAI are supported in all the TAs of the registration area, the S-NSSAIs of the partially allowed NSSAI are supported only in the TAs corresponding to the list of TAs (which are subset of the list of TAIs forming the registration area) associated with the S-NSSAI. If the UE supports partial network slice support in a registration area, the AMF may create a registration area for the UE considering the support of the S-NSSAIs of the requested NSSAI in the current TA and in the neighboring TAs. Further, the AMF provides to the UE in a registration accept message or in a UE configuration update command message, the partially allowed NSSAI or the S-NSSAIs rejected partially in the RA as follows:
If one or more of the requested S-NSSAI(s) are supported in a subset of the TAs of the (potential) registration area, the AMF may include such S-NSSAI(s) in the partially allowed NSSAI and corresponding mapping information of the S-NSSAI(s) of the partially allowed NSSAI to the home public land mobile network (HPLMN) S-NSSAI(s). For each S-NSSAI of the partially allowed NSSAI, the AMF provides a list of TAs where the S-NSSAI is supported. The UE is considered registered with the S-NSSAI in the whole registration area. The AMF also provides the partially allowed NSSAI (without indication of the TA list where the partially allowed S-NSSAIs are supported) to the NG-RAN together with the UE's context; and
Alternatively, the AMF may reject the S-NSSAI(s) with reject cause indicating “partially in the RA.” For each S-NSSAI of the S-NSSAIs rejected partially in the RA, the AMF provides a list of TAs for which the S-NSSAI is supported or not supported.

When the UE stores partially allowed NSSAI, the following applies:
The UE is considered registered with an S-NSSAI of the partially allowed NSSAI in the whole registration area. The UE does not trigger registration when moving between the TAs of support and non-support for the S-NSSAI within the RA;
The UE is allowed to initiate packet data unit (PDU) session establishment for the S-NSSAI only when the UE is in a TA where the S-NSSAI is supported;
When the UE has already established a PDU session with an S-NSSAI part of the partially allowed NSSAI, the UE is allowed to activate user plane resources of the PDU session only when the UE is in a TA part of the list of TAs associated with each S-NSSAI; and
When the user plane resources are activated for a PDU session to an S-NSSAI part of the partially allowed NSSAI and the UE moves to a TA which is not part of the list of TAs associated with the S-NSSAI, the user plane resources for the PDU session may be deactivated, but the PDU session context in the UE and session management function (SMF) is not released. The user plane resources for the PDU session may not be activated as long as the UE is located in a TA which is not part of the list of TAs associated with the S-NSSAI of the partially allowed NSSAI.

When the UE stores a S-NSSAI rejected partially in the RA with the associated list of TAs, the UE is allowed to initiate a mobility registration update procedure to request registration with the S-NSSAI only when the UE is in a TA supporting this S-NSSAI.

The network support for a network slice is defined on a per tracking area granularity. It may be beneficial to deploy some network slices such that the network slice has a limited geographical availability that is not matching existing tracking area boundaries. The operator can in this case decide to change the topology of the tracking areas so they match the boundaries of the network slice, or the operator may configure resources for the network slices in the cells of TAs where the network slices are to be available, and in areas of the TAs where the network slice is defined to be not available the cells are configured with zero resources.

The AMF receives from the operations, administration and maintenance (OAM), the information on availability of a network slice when the granularity is smaller than TA; i.e., if the network slice area of service (NS-AoS) includes TAs where the network slice is not available in some cells of the TA. In order to optimize the end-to-end behaviour, the AMF (based on NS-AoS information received from OAM) can configure supporting UEs with S-NSSAI location availability information, and the 5GCnetwork may need to monitor the S-NSSAI usage and enforce the NS-AoS, for example, if the UE does not support the S-NSSAI location availability information.

S-NSSAI location availability information defines additional restrictions to the usage of an S-NSSAI in TAs where the network slice availability does not match the TA boundaries. The AMF is configured per S-NSSAI whether to send the S-NSSAI location availability information to supporting UEs. The S-NSSAI location availability information sent to the UE includes, for each applicable S-NSSAI of the configured NSSAI, location information indicating the cells of TAs in the RA where the related S-NSSAI is available if the S-NSSAI is not available in all the cells of the TA. If the UE has indicated that the UE supports S-NSSAI location availability information in the 5GMM core network capability, the AMF may, based on OAM configuration, configure the UE with S-NSSAI location availability information for one or more S-NSSAIs when the AMF allocates an RA where the network slice availability does not match whole TAs, by including the S-NSSAI location availability information in the registration accept message or the UE configuration command message.

A UE that receives S-NSSAI location availability information applies the information as follows:
1. If the S-NSSAI is rejected in the RA or rejected partially in the RA or rejected with a cause code that allows attempting to register the S-NSSAI again, the UE can request the S-NSSAI only if the S-NSSAI location availability information indicates that the S-NSSAI is available at the cell where the UE is camping;
2. If the S-NSSAI is in the partially allowed NSSAI, the UE may not activate User Plane for any already established PDU session with that S-NSSAI if the UE is in a cell within the RA but outside the location information of the S-NSSAI; and
3. If the S-NSSAI is in the partially allowed NSSAI, and the UE in connection management (CM)-IDLE mode is moved to a cell outside the location information of the S-NSSAI, and the UE has an established PDU session with that S-NSSAI, the PDU session is kept.

FIG. 1 depicts a scenario, where the UE incorrectly retains network slice support information. In step 1, the UE sends uplink (UL) NAS message (for example, registration request message) including S-NSSAI-1 in requested NSSAI list. In step 2, a network function entity sends a down link (DL) NAS message (for example, registration accept) including S-NSSAI-1 in partially allowed NSSAI list or any other network slice support indication, informing supported list of TAs as TAI-1 and current registration area includes TAI-1 and TAI-2. In step 3, the network function entity sends the DL NAS message (for example, UE configuration update command) without including a network slice support information element. In step 4, the UE may retain network slice support information as the network entity did not include the network slice support information element. In step 5, if the network function entity (for example, AMF) does not support one or more network slice support information elements or features, keeping the network slice support information in the UE may lead to service disruption for the UE.

In an example scenario, the UE has been configured with S-NSSAI-1 as Partially allowed NSSAI with supported TA as TAI-1. The UE moves out of old registration area to a new registration area, where the corresponding AMF does not support partially allowed NSSAI feature. The AMF may not include partially allowed NSSAI IE while sending DL NAS message, for example, registration accept with registration area as TAI-3, TAI-4 to UE; for example, because the AMF does not support the respective feature, the UE may retain partially allowed list with supported TA information as TAI-1. In the above scenario, the UE cannot use S-NSSAI-1 slice as none of the tracking area code in the new registration area may match with the supported tracking area for S-NSSAI-1.

In case of PLMN or SNPN, in the UE, 5GS session management timers T3585 for the S-NSSAI based congestion control are started and stopped on a per S-NSSAI and PLMN or SNPN basis. If the 5GSM congestion re-attempt indicator IE with the ABO bit set to “The back-off timer is applied in all PLMNs or all equivalent SNPNs” is included in the 5GSM message with the 5GSM cause value #69 “insufficient resources for specific slice,” then the UE applies the timer T3585 for all the PLMNs or the equivalent SNPNs. Otherwise, the UE applies the timer T3585 for the registered PLMN or registered SNPN. If the timer T3585 applies for all the PLMNs or all the equivalent SNPNs, then the timer T3585 starts when the UE is registered in a VPLMN or an unsubscribed SNPN and the S-NSSAI is provided by the UE during the PDU session establishment, the timer T3585 is associated with the mapped S-NSSAI of the PDU session.

Additionally, if the 5GSM congestion re-attempt indicator IE with the CATBO bit set to “the back-off timer is applied in the current access type” is included in the 5GSM message with the 5GSM cause value #69 “insufficient resources for specific slice,” then the UE applies the timer T3585 for the current access type. Otherwise, the UE applies the timer T3585 for both 3GPP access type and non-3GPP access type and the UE may stop any running timer T3585 for the applied PLMN or SNPN and for the access different from the access from which the message is received.

The network may include the 5GSM congestion re-attempt indicator IE only if the network includes the back-off timer value IE and the 5GSM cause value is either #67 “insufficient resources for specific slice and DNN” or #69 “insufficient resources for specific slice.”

The network may include the back-off timer value IE to request a minimum time interval before procedure retry is allowed.

If the UE has indicated that the UE supports network slice replacement feature and the AMF determines to provide the mapping information between the S-NSSAI to be replaced and an alternative S-NSSAI to the UE, then the network may provide the UE with the alternative NSSAI. The alternative NSSAI is managed per access type independently, i.e., 3GPP access or non-3GPP access, and is applicable for the registration area.

Table 1 provides an overview of the back-off timers.

TABLE 1

| Timer ID | Cause of Start | Cause# and Reason |
|---|---|---|
| T3584 | PDU SESSION ESTABLISHMENT | Cause #67: Insufficient |
| | REJECT, PDU SESSION | resources for specific |
| | MODIFICATION REJECT, or PDU | slice and DNN |
| | SESSION RELEASE COMMAND | This 5GMM cause is |
| | received with 5GSM cause #67 and with a | sent by the network to |
| | timer value for T3584 | indicate that the |
| | PDU SESSION ESTABLISHMENT | requested service cannot |
| | REQUEST, or PDU SESSION | be provided due to |
| | MODIFICATION REQUEST received in | insufficient resources |
| | a DL NAS TRANSPORT message with | for specific slice and |
| | 5GMM cause #67 and with a timer value | DNN. |
| | for T3584 | |
| T3585 | PDU SESSION ESTABLISHMENT | Cause #69 - Insufficient |
| | REJECT, PDU SESSION | resources for specific |
| | MODIFICATION REJECT, or PDU | slice |
| | SESSION RELEASE COMMAND | This 5GMM cause is |
| | received with 5GSM cause #69 and with a | sent by the network to |
| | timer value for T3585 | indicate that the |
| | PDU SESSION ESTABLISHMENT | requested service cannot |
| | REQUEST, or PDU SESSION | be provided due to |
| | MODIFICATION REQUEST received in | insufficient resources |
| | a DL NAS TRANSPORT message with | for specific slice. |
| | 5GMM cause #69 and with a timer value | |
| | for T3585 | |

If the UE provides both the S-NSSAI to be replaced and the alternative S-NSSAI during a UL NAS transport message or 5GSM message for example a PDU session establishment procedure/PDU session modification message or DL NAS transport message or 5GSM message such as for example PDU session release command/PDU session modification reject, and included a back-off timer value along with a reject cause for example Cause #67: Insufficient resources for specific slice and DNN or Cause #69-Insufficient resources for specific slice then whether UE applies the back-off timer for the S-NSSAI to be replaced or the alternative S-NSSAI or the combination of S-NSSAI to be replaced and the alternative S-NSSAI is not clear; which can cause issues of UE/network sending unnecessary SM messages over a congested S-NSSAI.

FIG. 2 depicts an example scenario, where a PDU session establishment request is rejected by the network due to congestion. In step 1, the UE has sent a UL NAS transport or session management (SM) message for example PDU session establishment/modification request including S-NSSAI to be replaced (for example, S-NSSAI-1) and alternative S-NSSAI (for example, S-NSSAI-A). In step 2, the network function (for example, the AMF) has sent a DL NAS transport or SM message for example PDU session establishment/modification reject/PDU session release command including a back-off timer and a reject cause for example cause #67, #69. In step 3, since the UE received a back-off timer with a reject cause for example cause #67 or #69, the UE may decide whether to apply back-off timer for the S-NSSAI to be replaced or the alternative S-NSSAI, and the UE may decide whether to apply a back-off timer for the S-NSSAI to be replaced or the combination of S-NSSAI to be replaced and the alternative S-NSSAI.

FIG. 3 depicts a scenario, wherein the congestion/back-off timer is received from a network function, when the alternative S-NSSAI is included. In step 1, the UL NAS transport or SM message for example PDU session establishment/modification request for an alternative S-NSSAI (for example, S-NSSAI-A). In step 2, the DL NAS transport or SM message for example PDU session establishment/modification reject/PDU session release command including a back-off timer and a reject cause for example cause #67, #69. In step 3, since the UE received the back-off timer with the reject cause for example cause #67 or #69 for alternative S-NSSAI (i.e., S-NSSAI-A), the UE may decide whether to apply back-off timer for the S-NSSAI to be replaced (i.e., S-NSSAI-1) and in yet other embodiment the UE may decide whether to apply the back-off timer for the combination of S-NSSAI to be replaced and the alternative S-NSSAI (i.e., S-NSSAI-1+S-NSSAI-A).

Hence, there is a need in the art for solutions which will overcome the above-mentioned drawback(s), among others.

The principal object of embodiments herein is to disclose methods and systems for updating a partially allowed network slice selection assistance information (NSSAI) list.

Another object of embodiments herein is to disclose methods and systems for removing network slice support information stored in a user equipment (UE), if a non-access stratum (NAS) message from a network indicates to delete the network slice support information.

Another object of embodiments herein is to disclose methods and systems for handling a congestion/back-off timer for alternative single-NSSAI (S-NSSAI).

Another object of embodiments herein is to disclose methods and systems for applying a back-off timer to the S-NSSAI to be replaced (S-NSSAI-1)/alternative S-NSSAI (S-NSSAI-A)/combination of S-NSSAI-A+S-NSSAI-1, on receiving a packet data unit (PDU) session establishment request, when the network is congested.

Another object of embodiments herein is to disclose methods and systems for applying a back-off timer to the S-NSSAI-A/S-NSSAI-1/combination of S-NSSAI-A+S-NSSAI-1, on receiving a congestion timer from the network function while requesting an alternative S-NSSAI.

### SUMMARY

Accordingly, the embodiments herein provide a method for managing a network slice selection assistance information (NSSAI) list by a user equipment (UE). The method comprises receiving a first non-access stratum (NAS) message with a network slice support information from a network. The network slice support information comprises at least one of a list of tracking areas (TAs)/cells where at least one S-NSSAI is available or supported, and a list of TAs/cells where the S-NSSAI is not available or is not supported. The method comprises receiving a second NAS message with an indication to delete the network slice support information, from the network, on receiving the first NAS message. Thereafter, the method comprises deciding on deleting the network slice support information stored in the UE, based on the received second NAS message with an indication.

Accordingly, the embodiments herein provide a UE which comprises a processor and a memory. The processor is coupled with the memory, and configured to receive a first NAS message with a network slice support information from a network, receive a second NAS message with an indication to delete the network slice support information, from the network, on receiving the first NAS message, and decide on deleting the network slice support information stored in the UE, based on the received second NAS message with an indication.

Accordingly, the embodiments herein provide a network which comprises a processor and a memory. The processor is coupled with the memory, and configured to send a first NAS message with a network slice support information to a UE, determine if at least one S-NSSAI is included as part of the network slice support information on sending the first NAS message, determine to delete the network slice support information if no S-NSSAIs is included as part of the network slice support information, set a size of the network slice support information to zero in the network slice support information based on the determination of no S-NSSAIs is included as part of the network slice support information, and send a second NAS message with an indication of the size of the network slice support information to the UE to delete the network slice support information.

Accordingly, the embodiments herein provide a method for handling a congestion timer by a UE for an alternative single-NSSAI (S-NSSAI). The method comprises sending a request message to a network, through an uplink (UL) NAS message. The request message includes at least one of a S-NSSAI to be replaced, and an alternative S-NSSAI. The method comprises receiving a reject message from the network through a downlink (DL) NAS message. The reject message includes a back-off timer and a reject cause. The method comprises applying the received back-off timer to run for at least one of the S-NSSAI to be replaced, and the alternative S-NSSAI. Thereafter, the method comprises stopping sending additional request messages to the network for at least one of the S-NSSAI to be replaced, and the alternative S-NSSAI, until the back-off timer is running.

Accordingly, the embodiments herein provide a UE which comprises a processor and a memory. The processor is coupled with the memory, and configured to send a request message to a network, through a UL NAS message, where the request message includes at least one of a S-NSSAI to be replaced, and an alternative S-NSSAI. The processor is configured to receive a reject message from the network through a DL NAS message, where the reject message includes a back-off timer and a reject cause. The processor is configured to apply the received back-off timer to run for at least one of the S-NSSAI to be replaced, and the alternative S-NSSAI. Further, the processor is configured to stop sending additional request messages to the network for at least one of the S-NSSAI to be replaced, and the alternative S-NSSAI, until the back-off timer is running.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1 illustrates an example of a scenario when a UE incorrectly retains a network slice support information;

FIG. 2 illustrates an example of a scenario when PDU session establishment request is rejected by the network due to congestion;

FIG. 3 illustrates an example of a scenario when a congestion/back-off timer is received from a network function and an alternative S-NSSAI is included;

FIG. 4 illustrates an example of a system for managing a NSSAI list and a congestion timer according to embodiments as disclosed herein;

FIG. 5 illustrates an example of a method for managing a NSSAI list by the UE according to embodiments as disclosed herein;

FIG. 6 illustrates an example of a method for managing the NSSAI list by a network according to embodiments as disclosed herein;

FIG. 7 illustrates an example of a scenario when the UE removes the network slice support information and an IE is not included according to embodiments as disclosed herein;

FIG. 8 illustrates an example of a method for handling a congestion timer by the UE for an alternative S-NSSAI according to embodiments as disclosed herein;

FIG. 9 illustrates an example of a scenario when a back-off timer is applied to either one or all of the S-NSSAI-A/S-NSSAI-1/combination of S-NSSAI-1+S-NSSAI-A, on receiving a PDU session establishment reject and the network is congested according to embodiments as disclosed herein; and

FIG. 10 illustrates an example of a scenario when a back-off timer is applied to either one or all of the S-NSSAI-A/S-NSSAI-1/combination of S-NSSAI-1+S-NSSAI-2, on receiving the congestion timer from the network function and the UE sent an alternative S-NSSAI according to embodiments as disclosed herein.

### DETAILED DESCRIPTION

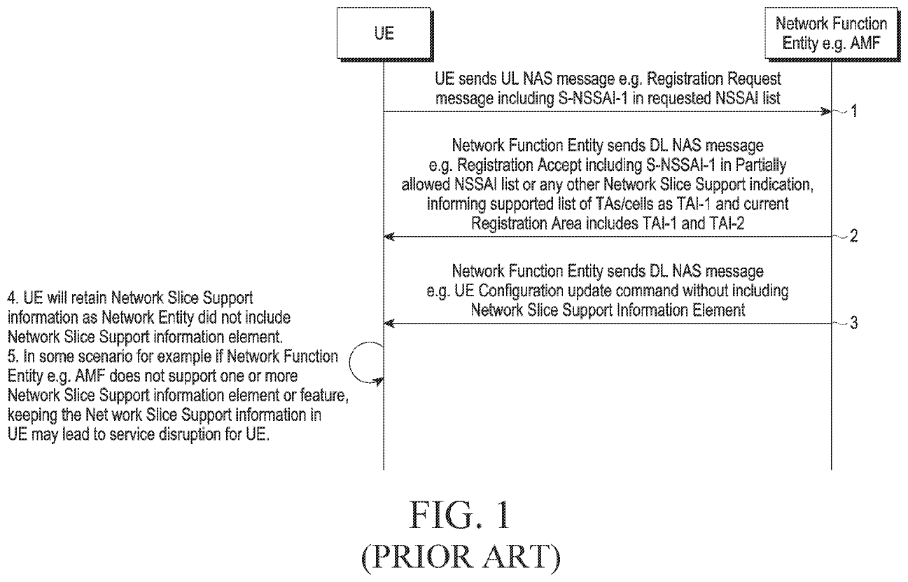

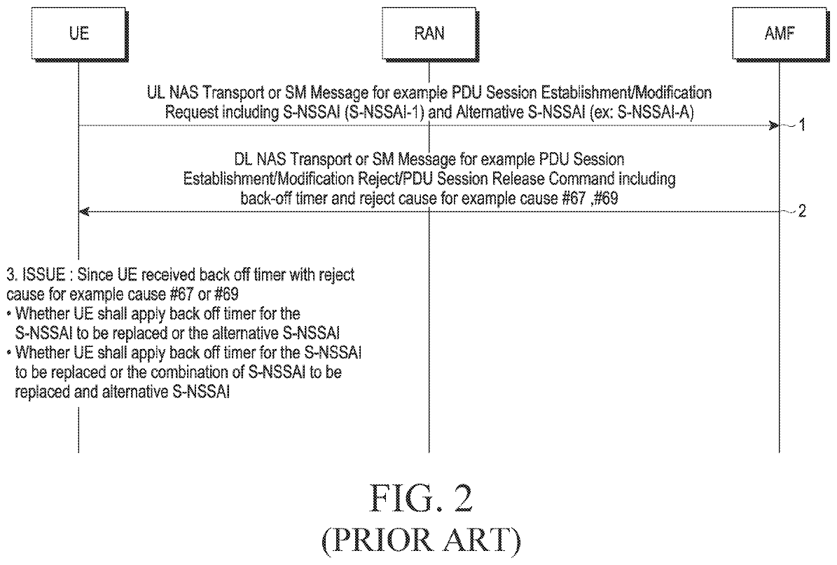

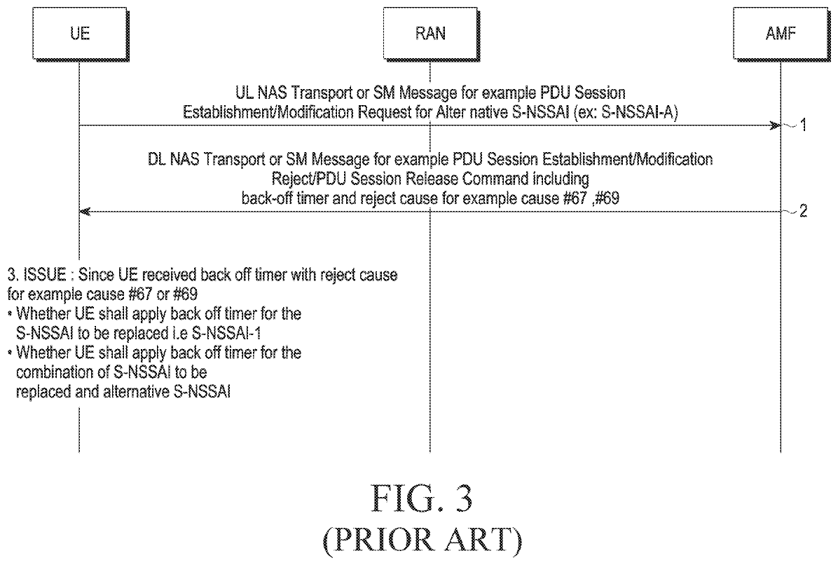

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising,” “having” and “including” are to be construed as open-ended terms unless otherwise noted.

The words/phrases “exemplary,” “example,” “illustration,” “in an instance,” “and the like,” “and so on,” “etc.,” “etcetera,” “e.g.,”, “i.e.,” are merely used herein to mean “serving as an example, instance, or illustration.” Any embodiment or implementation of the present subject matter described herein using the words/phrases “exemplary,” “example,” “illustration,” “in an instance,” “and the like,” “and so on,” “etc.,” “etcetera,” “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

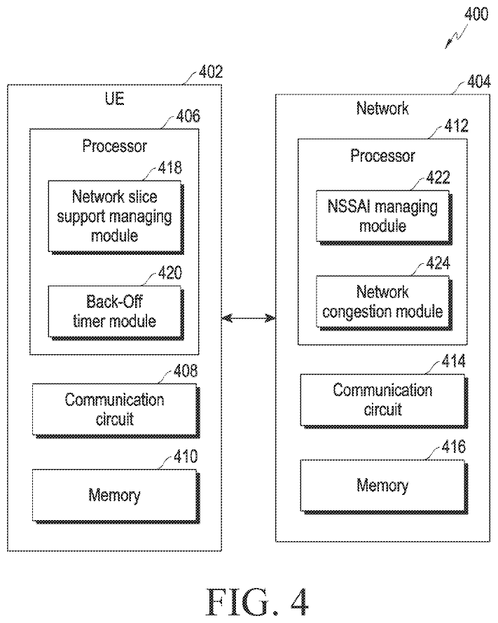

The embodiments herein provide methods and systems for updating partially allowed network slice selection assistance information (NSSAI) list, and handling a congestion timer for alternative single-NSSAI (S-NSSAI). Referring now to the drawings, and more particularly to FIGS. 4 through 10, where similar reference characters denote corresponding features consistently throughout the figures, there are shown embodiments.

The embodiments herein use a partially allowed NSSAI term which indicates S-NSSAIs values, the UE could use in a serving public land mobile network (PLMN) or standalone non-public network (SNPN) in some of the tracking areas (TAs) in a current registration area. Each S-NSSAI in the partially allowed NSSAI is associated with a list of TAs where the S-NSSAI is supported.

The embodiments herein use a network slice area of service (NSAoS) term which indicates the area where a UE can access and get service of a particular network slice as more than zero resources are allocated to the network slice in the NG-RAN cells.

The embodiments herein use a S-NSSAI location availability information term which indicates that the S-NSSAI location availability information sent to the UE includes, for each applicable S-NSSAI of the configured NSSAI, location information indicating the cells of TAs in a registration area (RA) where the related S-NSSAI is available if the S-NSSAI is not available in all the cells of the TA.

The embodiments herein use an alternative NSSAI (S-NSSAI-A) term which indicates a list of mapping information between the S-NSSAI to be replaced (S-NSSAI-1) and the alternative S-NSSAI (S-NSSAI-A).

The embodiments herein use a partially rejected NSSAI term which indicates the S-NSSAI(s) is rejected by the network in some TAs but not all TAs of the registration area. Each S-NSSAI in the partially rejected NSSAI is associated with a list of TAs where the S-NSSAI is rejected.

The embodiments herein use an on-demand S-NSSAI term which indicates an S-NSSAI that the UE is allowed to be registered with the network only when this S-NSSAI is used by the UE to establish a PDU session for user data transmission.

FIG. 4 depicts a system 400 for managing a network slice selection assistance information (NSSAI) list and a congestion timer. The system 400 comprises a user equipment (UE) 402, and a network 404. The UE 402 further comprises a processor 406, a communication circuit 408 (e.g., a transceiver performing a transmission and reception of a signal), and a memory 410. The network 404 further comprises a processor 412, a communication circuit 414, and a memory 416.

In an embodiment herein, the processor 406 of the UE 402 is configured to receive an indication from the network 404 on a network slice support information to delete the partially allowed NSSAI or partially rejected NSSAI. The processor 406 of the UE 402 is configured to handle a congestion/back-off timer for alternative single-NSSAI (S-NSSAI). The processor 406 of the UE 402 further comprises a network slice support managing module 418, and a back-off timer module 420.

In an embodiment herein, the network slice support managing module 418 can receive a first non-access stratum (NAS) message with a network slice support information from the network 404. The network slice support information includes a list of TAs/cells where at least one S-NSSAI is available or is supported, and a list of TAs/cells where the S-NSSAI is not available or is not supported. The network slice support information can include at least one of a partially allowed NSSAI list, a partially rejected NSSAI list, and a network slicing area of service (NS-AoS).

The network slice support managing module 418 can receive a second NAS message with an indication to delete the network slice support information, from the network 404, on receiving the first NAS message. The network slice support managing module 418 can decide on deleting the network slice support information stored in the UE 402, based on the received second NAS message with the indication.

In an embodiment herein, the network slice support managing module 418 can delete the network slice support information stored in the UE 402, if the second NAS message is received with network slice support information with the indication of the network slice support information size is set to value zero is received from the network 404.

In an embodiment herein, the network slice support managing module 418 can retain the network slice support information stored in the UE 402, based on receiving the second NAS message without the indication of the network slice support information, from the network 404.

In an embodiment herein, the network slice support managing module 418 can delete the network slice support information for a current registration area.

In an embodiment herein, the back-off timer module 420 can send a request message to the network 404, through an UL NAS message. The request message includes at least one of a S-NSSAI to be replaced (S-NSSAI-1), and an alternative S-NSSAI (S-NSSAI-A). The back-off timer module 420 can receive a reject message from the network 404 through a DL NAS message. The reject message includes a back-off timer and a reject cause. The back-off timer module 420 can apply the received back-off timer to run for at least one of the S-NSSAI to be replaced, and the alternative S-NSSAI. The back-off timer module 420 can stop sending additional request messages to the network for at least one of the S-NSSAI to be replaced, and the alternative S-NSSAI, until the back-off timer is running. The back-off timer module 420 stops to send additional request messages to stop initiating at least one of a PDU session establishment procedure, a PDU session modification procedure, and a NAS transport procedure for sending a cellular Internet of Things (CIoT) user data.

In an embodiment herein, the UE 402 can stop the back-off timer for the S-NSSAI that has been replaced, after receiving the updated alternative S-NSSAI from the network 404. In an embodiment herein, the UE 402 can stop the back-off timer for the S-NSSAI that has been replaced, and the alternative S-NSSAI, after receiving the updated alternative S-NSSAI from the network 404. In an embodiment herein, the UE 402 stops the back-off timer for the combination of the S-NSSAI that has been replaced, and the S-NSSAI that has been replaced in the alternative S-NSSAI, after receiving the updated alternative S-NSSAI from the network 404.

In an embodiment herein, the processor 412 of the network 404 further comprises a NSSAI managing module 422, and a network congestion module 424.

In an embodiment herein, the NSSAI managing module 422 can send the first NAS message with the network slice support information, where the network slice support information includes the list of TAs/cells where S-NSSAI is available or supported, and the list of TAs/cells where the S-NSSAI is not available or not supported.

In an embodiment herein, the NSSAI managing module 422 can determine if at least one S-NSSAI is included as part of the network slice support information. The NSSAI managing module 422 can determine to delete the network slice support information, if no S-NSSAIs is included as part of the network slice support information. The NSSAI managing module 422 can set a size of the network slice support information to zero in the network slice support information, based on the determination of no S-NSSAIs is included as part of the network slice support information. The NSSAI managing module 422 can send the second NAS message with the indication of the size of the network slice support information, to delete the network slice support information, to the UE 402. The second NAS message with the indication includes the size of an IE of the network slice support information which is set to value zero. The size of the IE of the network slice support information with value zero indicates that the network slice support information does not include S-NSSAI(s). In an embodiment herein, the NSSAI managing module 422 skips including the indication in the second NAS message during a periodic registration.

In an embodiment herein, the network congestion module 424 can receive a request message from the back-off timer module 420 of the UE 402, through the UL NAS message. The request message includes the S-NSSAI to be replaced, and the alternative S-NSSAI. The network congestion module 424 can send a reject message through the DL NAS message, where the reject message includes the back-off timer and the reject cause.

In an embodiment herein, the network congestion module 424 can verify if the back-off timer is running at UE side for the S-NSSAI that has been replaced, and the S-NSSAI has been replaced in the alternative S-NSSAI. The network congestion module 424 can remove mapping for the S-NSSAI that has been replaced. The network congestion module 424 can update the alternative S-NSSAI with the removed mapping. The network congestion module 424 can send the updated alternative S-NSSAI to the UE 402. The UE 402 stops the back-off timer for the S-NSSAI that has been replaced, after receiving the updated alternative S-NSSAI.

In an embodiment herein, the network congestion module 424 can verify, if the back-off timer is running at the UE side for the S-NSSAI that has been replaced in the alternative S-NSSAI. The network congestion module 424 can remove mapping for the S-NSSAI that has been replaced, and update the alternative S-NSSAI with the removed mapping. The network congestion module 424 can send the updated alternative S-NSSAI to the UE 402. The UE 402 stops the back-off timer for the S-NSSAI that has been replaced, and the alternative S-NSSAI, after receiving the updated alternative S-NSSAI.

In an embodiment herein, the network congestion module 424 can verify if the back-off timer is running for combination of the S-NSSAI that has been replaced, and the S-NSSAI that has been replaced in the alternative S-NSSAI. The network congestion module 424 can remove mapping for the S-NSSAI that has been replaced, and update the alternative S-NSSAI with the removed mapping. The network congestion module 424 can send the updated alternative S-NSSAI to the UE 402. The UE 402 stops the back-off timer for the combination of the S-NSSAI that has been replaced, and the S-NSSAI that has been replaced in the alternative S-NSSAI, after updating the alternative S-NSSAI.

In an embodiment herein, the processor 406, and the processor 412 can process and execute data of a plurality of modules of the UE 402, and the network 404 respectively. The processor 406, and the processor 412 can be configured to execute instructions stored in the memory 410, and the memory 416 respectively. The processor 406, and the processor 412 may comprise one or more of microprocessors, circuits, and other hardware configured for processing. The processor 406, and the processor 412 can be at least one of a single processer, a plurality of processors, multiple homogeneous or heterogeneous cores, multiple central processing units (CPUs) of different kinds, microcontrollers, special media, and other accelerators. The processor 406, and the processor 412 may be an application processor (AP), a graphics-only processing unit (such as a graphics processing unit (GPU), a visual processing unit (VPU)), and/or an artificial intelligence (AI)-dedicated processor (such as a neural processing unit (NPU)).

In an embodiment herein, the plurality of modules of the processor 406, and the processor 412 of the UE 402, and the network 404 can communicate via the communication circuit 408, and the communication circuit 414 respectively. The communication circuit 408, and the communication circuit 414 may be in the form of either a wired network or a wireless communication network module. The wireless communication network may comprise, but not limited to, global positioning system (GPS), global system for mobile communications (GSM), Wi-Fi, Bluetooth low energy, near-field communication (NFC), and so on. The wireless communication may further comprise one or more of Bluetooth, ZigBee, a short-range wireless communication (such as ultra-wideband (UWB)), and a medium-range wireless communication (such as Wi-Fi) or a long-range wireless communication (such as 3G/4G/5G/6G and non-3GPP technologies or WiMAX), according to the usage environment.

In an embodiment herein, the memory 410, and the memory 416 may comprise one or more volatile and non-volatile memory components which are capable of storing data and instructions of the modules of the of the UE 402, and the network 404 to be executed. Examples of the memory 410, and the memory 416 can be, but not limited to, NAND, embedded multi media card (eMMC), secure digital (SD) cards, universal serial bus (USB), serial advanced technology attachment (SATA), solid-state drive (SSD), and so on. The memory 410, and the memory 416 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories.

In addition, the memory 410, and the memory 416 may, in some examples, be considered a non-transitory storage medium. The term “non-transitory” may indicate that the storage medium is not embodied in a carrier wave or a propagated signal. However, the term “non-transitory” should not be interpreted to mean that the memory 410, and the memory 416 is non-movable. In certain examples, a non-transitory storage medium may store data that can, over time, change (for example, in random access memory (RAM) or cache).

FIG. 4 shows example modules of the UE 402, and the network 404, but it is to be understood that other embodiments are not limited thereon. In other embodiments, the UE 402, and the network 404 may include less or more number of modules. Further, the labels or names of the modules are used only for illustrative purpose and does not limit the scope of the present disclosure. One or more modules can be combined together to perform same or substantially similar function in the UE 402, and the network 404 respectively.

The network 404 may provide, to the UE 402, the partially allowed NSSAI. When a new partially allowed NSSAI for a PLMN or SNPN is received, and the new partially allowed NSSAI includes one or more S-NSSAI(s), the UE 402 may replace any stored partially allowed NSSAI for the PLMN and its equivalent PLMN(s) in the registration area or the SNPN via the 3GPP access with the new partially allowed NSSAI for the PLMN or SNPN. When a new partially allowed NSSAI for a PLMN or SNPN is received and the new partially allowed NSSAI does not include any S-NSSAI(s), the UE 402 may delete any stored partially allowed NSSAI for this PLMN and its equivalent PLMN(s) in the registration area or the SNPN via the 3GPP access.

When a new partially rejected NSSAI is received without any S-NSSAI(s), the UE 402 may delete any stored partially rejected NSSAI for the current registration area.

Table 2 indicates following Information Elements (IEs) as network slice support information elements: S-NSSAI location validity information, S-NSSAI time validity information, partially allowed NSSAI, and partially rejected NSSAI.

TABLE 2

| IEI | Information Element | Type/Reference | Presence | Format | Length |
|---|---|---|---|---|---|
| TBD | S-NSSAI location validity | S-NSSAI location validity | O | TLV-E | TBD |
| | information | information | | | |
| | | 9.11.3.39 | | | |
| TBD | S-NSSAI time validity | S-NSSAI time validity | O | TLV-E | TBD |
| | information | information | | | |
| | | 9.11.3.40 | | | |
| TBD | Partially allowed NSSAI | Partial NSSAI | O | TLV-E | 13-923 |
| | | 9.11.3.103 | | | |
| TBD | Partially rejected NSSAI | Partial NSSAI | O | TLV-E | 13-923 |
| | | 9.11.3.103 | | | |

If a network function entity indicates its support for the network slice information elements, and if the respective network slice support information IE is included with size zero, then the UE 402 deletes respective network slice support information.

For example, the network function entity (for example, AMF) indicates support for a partially allowed NSSAI in DL NAS message (for example, registration accept message), and provides a partially allowed NSSAI as S-NSSAI-1 with support TA as TAI-1. Now, if the network function entity sends the DL NAS message by including the partially allowed NSSAI information element with size zero, then the UE 402 may delete all S-NSSAI i.e., S-NSSAI-1 from the partially allowed NSSAI list.

The AMF may set the length of partial NSSAI contents to 0, if there are no S-NSSAIs to deliver in a set of tracking areas of a registration area, and the UE may delete any existing stored partially allowed NSSAI for the current registration area or partially rejected NSSAI for the current registration area.

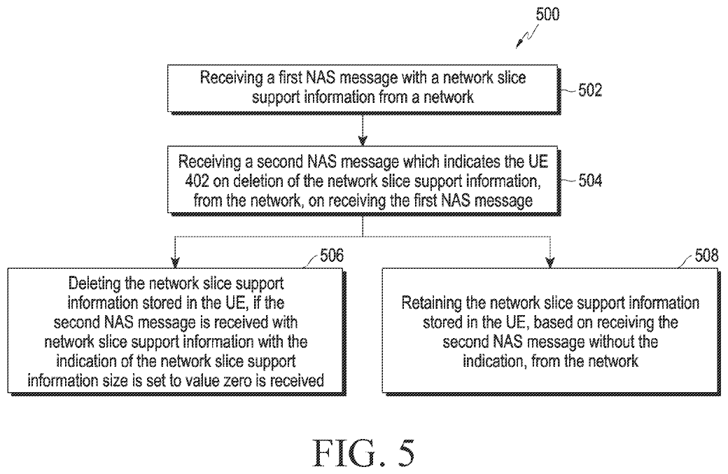

FIG. 5 depicts a method 500 for managing a NSSAI list by the UE 402. The method 500 comprises receiving, by the UE 402, a first NAS message with the network slice support information from the network 404, as depicted in step 502. The network slice support information comprises a list of TAs/cells where at least one S-NSSAI is available or is supported, and a list of TAs/cells where at least one S-NSSAI is not available or is not supported.

The method 500 comprises receiving, by the UE 402, a second NAS message, from the network 404, which indicates the UE 402 on deletion of the network slice support information, on receiving the first NAS message, as depicted in step 504. The method 500 comprises deleting, by the UE 402, the network slice support information stored in the UE 402, if the second NAS message is received with network slice support information with the indication of the network slice support information size is set to value zero is received, as depicted in step 506. Thereafter, the method 500 comprises retaining the network slice support information stored in the UE 402, based on receiving the second NAS message without the indication, from the network 404, as depicted in step 508.

The various actions in method 500 may be performed in the order presented, in a different order or simultaneously. Further, in some embodiments, some actions listed in FIG. 5 may be omitted.

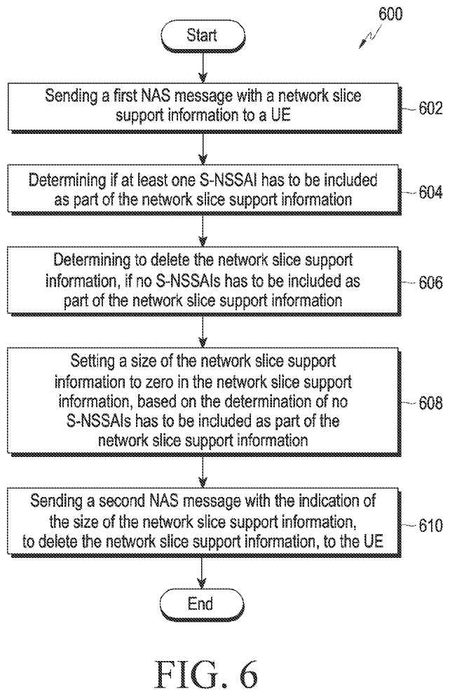

FIG. 6 depicts a method 600 for managing the NSSAI list by the network 404. The method 600 comprises sending, by the network 404, a first NAS message with a network slice support information to the UE 402, as depicted in step 602. The method 600 comprises determining, by the network 404, if at least one S-NSSAI is included as part of the network slice support information, as depicted in step 604, on sending the first NAS message. The method 600 comprises determining, by the network 404, to delete the network slice support information, if no S-NSSAIs is included as part of the network slice support information, as depicted in step 606.

Thereafter, the method 600 comprises setting, by the network 404, a size of the network slice support information to zero in the network slice support information, based on the determination of no S-NSSAIs is included as part of the network slice support information, as depicted in step 608. Later, the method 600 comprises sending, by the network 404, a second NAS message with the indication of the size of the network slice support information, to delete the network slice support information, to the UE 402, as depicted in step 610.

The various actions in method 600 may be performed in the order presented, in a different order or simultaneously. Further, in some embodiments, some actions listed in FIG. 6 may be omitted.

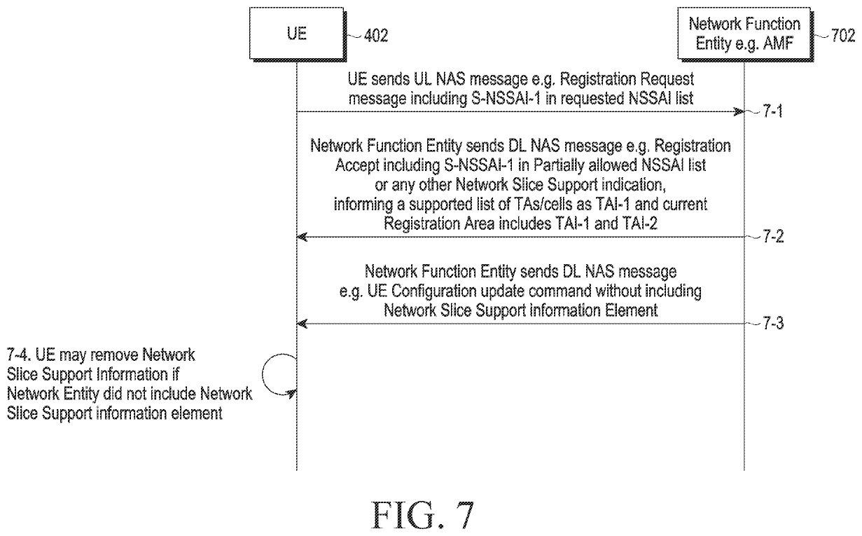

FIG. 7 depicts a scenario where the UE 402 removes network slice support information, if the IE is not included. In step 7-1, the UE 402 sends a UL NAS message (for example, a registration request message) including S-NSSAI-1 in a requested NSSAI list. In step 7-2, the network function entity 702 (for example, AMF (also called as old AMF in this scenario)) sends a DL NAS message (for example, a registration accept message including S-NSSAI-1) in a partially allowed NSSAI list or any other network slice support information, informing a supported list of TAs as TAI-1, and a current registration area includes TAI-1 and TAI-2. In step 7-3, the network function entity 702 sends a DL NAS message, for example, a UE configuration update command without including network slice support information element; or in step 7-3, the UE 402 may have moved out of a registration area, and the UE may trigger the registration procedure, sending registration request message to the AMF 702. The AMF 702 (the target AMF can be an old AMF or a new AMF) sends the registration accept message without including the network slice support information element. In step 7-4, the UE 402 may remove/delete the network slice support information from the UE storage if the network entity did not include the network slice support information element in the DL message. In an embodiment herein, the network function entity 702 may optionally provide the network slice support information to the UE 402 in the NAS message (for example, registration accept or the UE configuration update command), but with zero information i.e., the contents are null (or zero), and only IE octets are provided; in other words, an explicit indication is provided to the UE 402 to delete the respective network slice support information stored (by providing respective IE but with length or size zero) at the UE 402. In case of a periodic registration, the network function entity 702 (like the AMF) may not include the network slice support information in the NAS message (for example, registration accept or the UE configuration update command), then the UE 402 may continue to store the information that the UE 402 has, without impacting its contents.

In an embodiment herein, the network function entity 702 may indicate in the DL NAS message, for example, registration accept for its support for at least one or more of network slice support information to the UE 402. Based on the indication from the network function entity 702, the UE 402 may decide when to retain the previous network slice support information or to delete at least one of network slice support information. As per current embodiment, the UE 402 may take any of below decisions based on the network slice support information indication to the UE 402 as shown in examples below.

In one example, if the network function entity 702 indicates its support for the network slice information elements and if respective network slice support information IE is not included by the network function entity 702 (e.g., AMF), the UE 402 retains the network slice support information.
For example, the network function entity 702, e.g., AMF, indicates support for a partially allowed NSSAI in the DL NAS message, e.g., registration accept message, and provides partially allowed NSSAI as S-NSSAI-1 with support TA as TAI-1. Now if the network function entity 702 sends the DL NAS message, e.g., registration accept message, without including the partially allowed NSSAI information element, the UE 402 may consider S-NSSAI-1 as partially allowed NSSAI with supported TA as TAI-1.

In another example, if the network function entity 702 does not indicate its support for the network slice information elements and if respective network slice support information IE is not included by the network function entity 702, the UE 402 deletes the network slice support information.
For example, the network function entity 702, e.g., AMF, indicates the partially allowed NSSAI not supported in the DL NAS message, e.g., registration accept message. Now, if the network function entity 702 sends the DL NAS message, e.g., registration accept, without including the partially allowed NSSAI information element, then the UE 402 may remove previous stored partially allowed NSSAI information. In another embodiment, the UE 402 may also remove the partially allowed NSSAI information once the UE 402 receives indication from the network function entity 702 that the partially allowed NSSAI is not supported.

In yet another example, if the network function entity 702 indicates its support for the network slice information elements, and if respective network slice support information IE is included with size zero, then the UE 402 deletes respective network slice support information.
For example, the network function entity 702, e.g., AMF, indicates support for the partially allowed NSSAI in the DL NAS message, e.g., registration accept message, and provides the partially allowed NSSAI as S-NSSAI-1 with support TA as TAI-1. Now if the network function entity 702 sends the DL NAS message by including the partially allowed NSSAI information element with size zero, then the UE 402 may delete all S-NSSAI i.e., S-NSSAI-1 from the partially allowed NSSAI list.

In an embodiment herein, the UE 402 may take any of below decisions based on the network slice support information indication to the UE 402 as shown in examples below.

In one example, if respective network slice support information IE is not included by the network function entity 702 (e.g., AMF) in the NAS message, then the UE 402 retains the network slice support information.
If the network function entity 702, e.g., AMF, provides in the NAS message like registration accept message, and provides the partially allowed NSSAI as S-NSSAI-1 with support TA as TAI-1; later again if the network function entity 702 sends the DL NAS message, e.g., registration accept message, without including the partially allowed NSSAI information element, then the UE 402 may consider S-NSSAI-1 as partially allowed NSSAI with supported TA as TAI-1. Optionally this behavior, the UE 402 can apply only during periodic registration procedure and not during initial registration or mobility registration procedure.

In another example, if AMF in the DL NAS message, e.g., registration accept message provides the partially allowed NSSAI as S-NSSAI-1 with support TA as TAI-1, and now if the network function entity 702 sends the DL NAS message like registration accept or UE configuration command again at later point of time, by including the partially allowed NSSAI information element with length (or size) zero, then the UE 402 may delete all S-NSSAI, i.e., in this example S-NSSAI-1 from the partially allowed NSSAI list.
For example, if an IE is provided to the UE 402 with length of contents as zero, i.e., Octets include only TAG NAME, and LENGTH with 0 indicating there are no contents, then the UE 402 may delete the partially allowed NSSAI stored at the UE 402. This embodiment is illustrated for partially allowed NSSAI but this is equally applicable for any of the elements of network slice support information/indication.

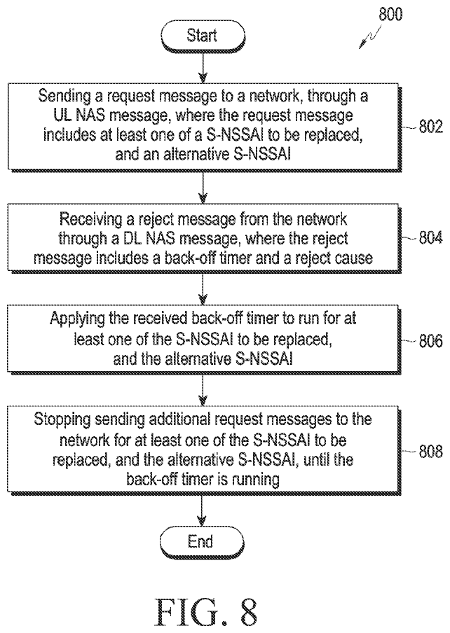

FIG. 8 depicts a method 800 for handling a congestion timer by the UE 402 for an alternative single-NSSAI (S-NSSAI). The method 800 comprises sending, by the UE 402, a request message to the network 404, through a UL NAS message, as depicted in step 802. The request message includes at least one of a S-NSSAI to be replaced, and an alternative S-NSSAI. The method 800 comprises receiving, by the UE 402, a reject message from the network 404 through a DL NAS message, as depicted in step 804. The reject message includes a back-off timer and a reject cause.

Thereafter, the method 800 comprises applying, by the UE 402, the received back-off timer to run for at least one of the S-NSSAI to be replaced, and the alternative S-NSSAI, as depicted in step 806. The method 800 comprises stopping, by the UE 402, sending additional request messages to the network 404 for at least one of the S-NSSAI to be replaced, and the alternative S-NSSAI, until the back-off timer is running, as depicted in step 808.

The various actions in method 800 may be performed in the order presented, in a different order or simultaneously. Further, in some embodiments, some actions listed in FIG. 8 may be omitted.

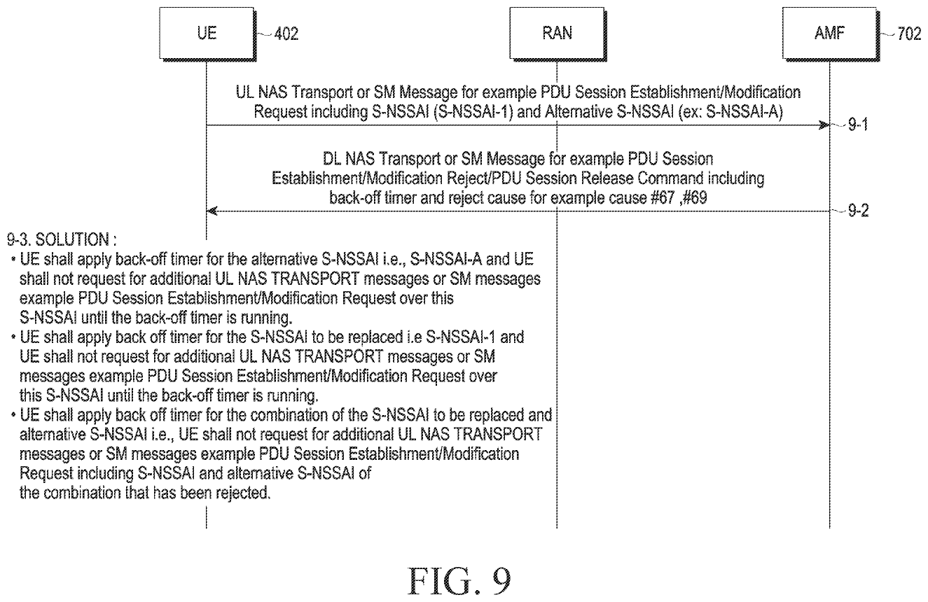

FIG. 9 depicts a scenario, where a back-off timer is applied to either one or all of the S-NSSAI-A/S-NSSAI-1/combination of S-NSSAI-1+S-NSSAI-A, on receiving a PDU session establishment reject, when the network 404 is congested. In step 9-1, the UE 404 has sent the UL NAS transport or a session management (SM) message, for example PDU session establishment/modification request including S-NSSAI to be replaced (for example, S-NSSAI-1) and alternative S-NSSAI (for example, S-NSSAI-A). In step 9-2, the network function entity 702 (for example, AMF) has sent the DL NAS transport or SM message, for example PDU session establishment/modification reject/PDU session release command including back-off timer, and reject cause for example cause #67, #69.

In step 9-3, the UE 404 may apply back-off timer for the alternative S-NSSAI (i.e., S-NSSAI-A) and the UE 404 may not request for additional UL NAS transport messages or SM messages (for example, PDU session establishment/modification request) over this S-NSSAI (acting as an alternative S-NSSAI) until the back-off timer is running; for example, the UE 404 starts the timer for S-NSSAI-A.

In an embodiment herein, the UE 404 may apply the back-off timer for the S-NSSAI to be replaced (i.e., S-NSSAI-1) and the UE 404 may not request for additional UL NAS transport messages or SM messages (for example, PDU session establishment/modification request) over this S-NSSAI until the back-off timer is running; for example, the UE 404 starts the timer for S-NSSAI-1.

In an embodiment herein, the UE 404 may apply the back-off timer for the combination of the S-NSSAI to be replaced and alternative S-NSSAI i.e., the UE 404 may not request for additional UL NAS transport messages or SM messages (for example, PDU session establishment/modification request) including S-NSSAI and alternative S-NSSAI combination that has been rejected; for example, the UE 404 starts the timer for the combination of S-NSSAI-1+S-NSSAI-A and does not trigger any 5GSM procedure for the combination of S-NSSAI-1+S-NSSAI-A.

If a back-off timer has been received for S-NSSAI-A (S2), then the UE 402 does not try for S-NSSAI-1+S-NSSAI-A (S1+S2).

In an embodiment herein, optionally the UE/AMF/session management function (SMF) may maintain the existing PDU sessions on the congested network slice: i.e., S-NSSAI-1/S-NSSAI-A/S-NSSAI-1+S-NSSAI-A for which the back-off timer is applied and running.

In an embodiment herein, optionally, the UE/AMF/SMF may locally release the existing PDU sessions on the congested network slice: i.e., S-NSSAI-1/S-NSSAI-A/S-NSSAI-1+S-NSSAI-A for which the back-off timer is applied.

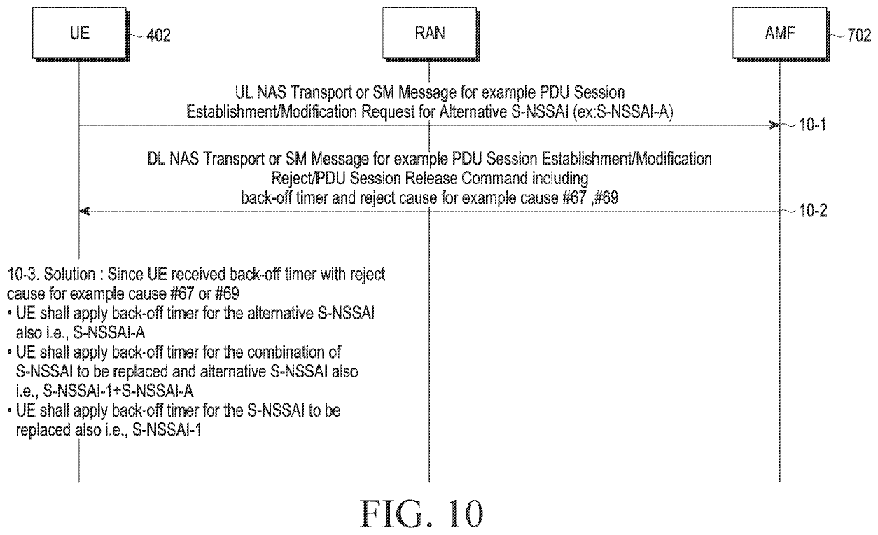

FIG. 10 depicts a scenario, where a back-off timer is applied to either one or all of the S-NSSAI-A/S-NSSAI-1/combination of S-NSSAI-1+S-NSSAI-2, on receiving the congestion timer from the network function, while the UE 402 sent an alternative S-NSSAI. In step 10-1, the UE 402 has sent a UL NAS transport or SM message for example PDU session establishment/modification request for alternative S-NSSAI (for example, S-NSSAI-A).

In step 10-2, the network function entity 702 (for example, AMF) has sent a DL NAS transport or SM message (for example, PDU session establishment/modification reject/PDU session release command) including back-off timer and reject cause for example cause #67, #69. In step 10-3, the UE 402 may apply the back-off timer for only alternative S-NSSAI (i.e., S-NSSAI-A); and the UE 402 may not request for additional UL NAS transport messages or SM messages (for example, PDU session establishment/modification request) using S-NSSAI-A and optionally may not apply the back-off timer for a combination of S-NSSAI-1+S-NSSAI-A or for S-NSSAI-1.

In an embodiment herein, the UE 402 may apply the back-off timer for the combination of the S-NSSAI to be replaced and alternative S-NSSAI; i.e., the UE 402 may not request for additional UL NAS transport messages or SM messages (for example, PDU session establishment/modification request) including S-NSSAI and alternative S-NSSAI; for example, the UE 402 starts the timer for the combination of S-NSSAI-1+S-NSSAI-A, and may not trigger any 5GSM procedure for the combination of S-NSSAI-1+S-NSSAI-A.

In an embodiment herein, the UE 402 may apply back-off timer for the S-NSSAI to be replaced (i.e., S-NSSAI-1) and the UE may not request for additional UL NAS transport messages or SM messages (for example, PDU session Establishment/Modification Request) over this S-NSSAI until the back-off timer is running; for example, the UE 404 starts the timer for S-NSSAI-1 along with S-NSSAI-A.

Consider that the S-NSSAI to be replaced is as follows: S-NSSAI-1, S1. The alternative S-NSSAI is as follows: S-NSSAI-A, S2 (as depicted in table 2). The PDU session-ID-1 is a PDU session of Data Network Name (DNN)-1+S-NSSAI-1.

TABLE 3

| S-NSSAI | Alternative S-NSSAI |
|---|---|
| S-NSSAI-1 | S-NSSAI-A |
| S1 | S2 |

Consider that the UE 402 sent a UL NAS message for example PDU session establishment/modification request with combination of S-NSSAI-1+S-NSSAI-A. The network function entity 702 (for example, AMF) has rejected the request with a DL NAS message for example PDU session establishment/modification reject, and optionally including a reject cause such as cause #67 or cause #69 etc., and optionally including a back-off timer. It is not clear whether the back-off timer is applicable for S-NSSAI-1 or S-NSSAI-A or combination of S-NSSAI-1+S-NSSAI-A. In an embodiment herein, the UE 402 may apply the back-off timer for the combination of S-NSSAI-1+S-NSSAI-A; and the UE 402 may not request/send for additional UL NAS transport messages or SM messages (for example, PDU session establishment/modification request) using the combination of S-NSSAI-1+S-NSSAI-A. In an embodiment herein, the UE 402 may apply the back-off timer for alternative S-NSSAI (i.e., S-NSSAI-A); and the UE 402 may not request/send additional UL NAS transport messages or SM messages (for example, PDU session establishment/modification request) using S-NSSAI-A. In an embodiment herein, the UE 402 may apply the back-off timer for S-NSSAI to be replaced (i.e., S-NSSAI-1); and the UE 402 may not request/send additional UL NAS transport messages or SM messages (for example, PDU session establishment/modification request) using S-NSSAI-1.

Consider that the UE sent a UL NAS message (for example, PDU session establishment/modification request) using S-NSSAI-A. The network function (for example, AMF) has rejected the request with a DL NAS message (for example, PDU session establishment/modification reject) and optionally including a reject cause such as cause #67 or cause #69 etc., and optionally including a back-off timer. It is not clear whether the back-off timer is applicable for only S-NSSAI-A or combination of S-NSSAI-1+S-NSSAI-A or S-NSSAI-1 also. In an embodiment herein, the UE 402 apply the back-off timer for the combination of S-NSSAI-1+S-NSSAI-A; and the UE 402 may not request for additional UL NAS transport messages or SM messages (for example, PDU session Establishment/Modification Request) using the combination of S-NSSAI-1+S-NSSAI-A. In an embodiment herein, the UE 402 may apply the back-off timer for only alternative S-NSSAI (i.e., S-NSSAI-A); and the UE 402 may not request for additional UL NAS transport messages or SM messages (for example, PDU session establishment/modification request) using S-NSSAI-, and optionally may not apply the back-off timer for combination of S-NSSAI-1+S-NSSAI-A. In an embodiment herein, the UE 402 may apply the back-off timer for S-NSSAI to be replaced (i.e., S-NSSAI-1) also along with S-NSSAI-A; and the UE 402 may not request for additional UL NAS transport messages or SM messages (for example, PDU session establishment/modification request) using S-NSSAI-1.

Embodiments herein can stop the timer, on the mapping of the alternative S-NSSAI being removed. On removing the mapping, the timer of the following is also stopped:
a) If a timer T3584 or timer T3585 is running for the S-NSSAI that was replaced (for example, S-NSSAI-1) and that was replaced in alternative NSSAI (for example, S-NSSAI-A); the AMF provides the updated alternative NSSAI with mapping is removed for the S-NSSAI-1, the UE 402 may stop the timer for S-NSSAI-1.
b) If the timer T3584 or timer T3585 is running for the combination of S-NSSAI (for example, S-NSSAI-1) that was replaced and the S-NSSAI that was replaced in alternative NSSAI (for example, S-NSSAI-A) (i.e., S-NSSAI-1+S-NSSAI-2); the AMF provides the updated Alternative NSSAI with mapping is removed (or deleted) for the S-NSSAI-1, the UE 402 may stop the timer for combination of S-NSSAI-1+S-NSSAI-A.
c) If the timer T3584 or timer T3585 is running for the S-NSSAI was replaced in alternative NSSAI (for example, S-NSSAI-A); the AMF provides the updated alternative NSSAI with mapping is removed for the S-NSSAI-1, the UE 402 may stop the timer for S-NSSAI-A/S-NSSAI-1.

Consider the S-NSSAI-1, S-1 as an example of the S-NSSAI to be replaced and S-NSSAI-A, S-2 is considered as an example of the alternative S-NSSAI. In this embodiment, the UE 402 may not use a S-NSSAI or combination of S-NSSAI to send 5GSM message implies the UE 402 may not initiate signaling message (for example, 5GSM or 5GMM) related to at least one or all the PDU session which belongs to the respective S-NSSAI or combination of S-NSSAI.

The term Illustrated-S-NSSAI hereafter is either S-NSSAI-1 or S-NSSAI-A or combination of S-NSSAI-1+S-NSSAI-A (as illustrated with examples in this embodiment) and is applied as per the behaviour described in this embodiment:

If T3584 is running or is deactivated, then the UE 402 is not allowed to initiate the:
a) PDU session establishment procedure;
b) PDU session modification procedure; or
c) NAS transport procedure for sending cIoT user data;

For the respective [Illustrated-S-NSSAI, no DNN] or [Illustrated-S-NSSAI, DNN] combination unless the UE is a UE configured for high priority access in selected PLMN or SNPN or to report a change of 3GPP PS data off UE status.

If the timer T3584 is running or is deactivated for all the PLMNs and is associated with an S-NSSAI other than no S-NSSAI, then
a) The UE registered in the Home Public Land Mobile Network (HPLMN) is not allowed to initiate the:
1) PDU session establishment procedure,
2) PDU session modification procedure, or
3) NAS transport procedure for sending cIoT user data,
   when the [Illustrated-S-NSSAI, no DNN] or [Illustrated-S-NSSAI, DNN] combination provided by the UE during the PDU session establishment is the same as the [Illustrated-S-NSSAI, no DNN] or [Illustrated-S-NSSAI, DNN] combination associated with the timer T3584 unless the UE is a UE configured for high priority access in selected PLMN or to report a change of 3GPP PS data off UE status; and
b) the UE registered in a Visited Public Land Mobile Network (VPLMN) is not allowed to initiate the:
1) PDU session establishment procedure,
2) PDU session modification procedure, or
3) NAS transport procedure for sending cIoT user data,
when the [mapped Illustrated-S-NSSAI, no DNN] or [mapped Illustrated-S-NSSAI, DNN] combination provided by the UE during the PDU session establishment is the same as the [Illustrated-S-NSSAI, no DNN] or [Illustrated-S-NSSAI, DNN] combination associated with the timer T3584 unless the UE is a UE configured for high priority access in selected PLMN or to report a change of 3GPP PS data off UE status.

The term Illustrated-S-NSSAI hereafter is either S-NSSAI-1 or S-NSSAI-A or combination of S-NSSAI-1+S-NSSAI-A (as illustrated with examples herein) and is applied as per the behaviour described herein.

If the timer T3584 is running or is deactivated for all the PLMNs and is associated with [no S-NSSAI, no DNN] or [no S-NSSAI, DNN] combination, then the UE is not allowed to initiate the:
a) PDU session establishment procedure;
b) PDU session modification procedure; or
c) NAS transport procedure for sending cIoT user data.

For [no Illustrated-S-NSSAI, no DNN] or [no Illustrated-S-NSSAI, DNN] combination in any PLMN unless the UE is a UE configured for high priority access in selected PLMN or to report a change of 3GPP PS data off UE status.

If T3585 is running or is deactivated, then the UE is neither allowed to initiate the PDU session establishment procedure nor the PDU session modification procedure for the respective S-NSSAI unless the UE is a UE configured for high priority access in selected PLMN or SNPN or to report a change of 3GPP Packet-Switched (PS) data off UE status.

If the timer T3585 is running or is deactivated for all the PLMNs and is associated with an S-NSSAI other than no S-NSSAI, then:
a) the UE registered in the HPLMN is not allowed to initiate the:
1) PDU session establishment procedure,
2) PDU session modification procedure, or
3) NAS transport procedure for sending cIoT user data,
when the Illustrated-S-NSSAI provided by the UE during the PDU session establishment is the same as the Illustrated-S-NSSAI associated with timer T3585 unless the UE is a UE configured for high priority access in selected PLMNs or to report a change of 3GPP PS data off UE status; and
b) the UE registered in a VPLMN is not allowed to initiate the:
1) PDU session establishment procedure,
2) PDU session modification procedure, or
3) NAS transport procedure for sending cIoT user data,
when the mapped Illustrated-S-NSSAI provided by the UE during the PDU session establishment is the same as the Illustrated-S-NSSAI associated the timer T3585 unless the UE is a UE configured for high priority access in selected PLMN or to report a change of 3GPP PS data off UE status.

If the timer T3585 is running or is deactivated for all the PLMNs and is associated with no Illustrated-S-NSSAI, then the UE 402 is not allowed to initiate the:
a) PDU session establishment procedure;
b) PDU session modification procedure; and/or
c) NAS transport procedure for sending cIoT user data,
for no Illustrated-S-NSSAI in any PLMN, unless the UE is a UE configured for high priority access in selected PLMN or SNPN or to report a change of 3GPP PS data off UE status.

The examples disclosed herein are with respect to SM congestion and blocking SM messages with respect to alternative S-NSSAI, however, it may be obvious to a person of ordinary skill in the art that the same applies for the S-NSSAI congestion on 5G MM case and similar/same solutions are adapted for the 5G MM congestion and their back-off timers.

Therefore, the AMF when the AMF determines to delete the partially allowed NSSAI list, the AMF sets the size to the zero and send the partially allowed NSSAI. The UE when the UE receives partially allowed NSSAI, with size zero i.e., does not include any S-NSSAI(s), the UE may delete any stored partially allowed NSSAI for this PLMN and its equivalent PLMN(s).

The AMF when the AMF determines to delete the partially rejected NSSAI list, the AMF sets the size to the zero and send the partially rejected NSSAI list. The UE when the UE receives the partially allowed NSSAI, with size zero i.e., without any S-NSSAI(s), the UE may delete any stored partially allowed NSSAI for this PLMN and its equivalent PLMN(s).

The embodiments disclosed herein can be implemented through at least one software program running on at least one hardware device and performing network management functions to control the network elements. The modules shown in FIG. 4 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of a user equipment (UE) for managing a network slice selection assistance information (NSSAI) list, the method comprising:
receiving, from a network, a registration accept message with at least one partial NSSAI;
receiving, from the network, a configuration update command message with at least one partial NSSAI; and
deleting the at least one partial NSSAI stored in the UE based on a length of the at least one partial NSSAI of the configuration update command message being zero.

2. The method as claimed in claim 1, wherein the at least one partial NSSAI comprises at least one of a partially allowed NSSAI and a partially rejected NSSAI.

3. The method as claimed in claim 1, wherein the length of the at least one partial NSSAI of the configuration update command message being zero indicates that the at least one partial NSSAI does not include a single-NSSAI (S-NSSAI).

4. The method as claimed in claim 1, further comprising:
retaining the at least one partial NSSAI stored in the UE based on the length of the at least one partial NSSAI of the configuration update command message not being zero.

5. A method of a network for managing a network slice selection assistance information (NSSAI) list, the method comprising:
transmitting a registration accept message with at least one partial NSSAI to a user equipment (UE);
setting a length of at least one partial NSSAI of a configuration update command message being zero; and
transmitting the configuration update command message to the UE.

6. The method as claimed in claim 5, wherein the at least one partial NSSAI comprises at least one of a partially allowed NSSAI and a partially rejected NSSAI.

7. The method as claimed in claim 5, wherein the length of the at least one partial NSSAI of the configuration update command message being zero indicates that the at least one partial NSSAI does not include a single-NSSAI (S-NSSAI).

8. A user equipment (UE) comprising:
a communication circuit; and
at least one processor operably coupled to the communication circuit, the at least one processor configured to:
receive, from a network, a registration accept message with at least one partial NSSAI,
receive, from the network, a configuration update command message with at least one partial NSSAI, and
delete the at least one partial NSSAI stored in the UE based on a length of the at least one partial NSSAI of the configuration update command message being zero.

9. The UE as claimed in claim 8, wherein the at least one partial NSSAI comprises at least one of a partially allowed NSSAI and a partially rejected NSSAI list.

10. The UE as claimed in claim 8, wherein the length of the at least one partial NSSAI of the configuration update command message being zero indicates that the at least one partial NSSAI does not include a single-NSSAI (S-NSSAI).

11. The UE as claimed in claim 8, wherein the at least one processor is further configured to retain the at least one partial NSSAI stored in the UE based on a length of the at least one partial NSSAI of the configuration update command message not being zero.

12. A network comprising:
a communication circuit; and
at least one processor operably coupled to the communication circuit, the at least one processor configured to:
transmit a registration accept message with at least one partial NSSAI to a user equipment (UE),
set a length of at least one partial NSSAI of a configuration update command message being zero, and
transmit the configuration update command message to the UE.

13. The network as claimed in claim 12, wherein the at least one partial NSSAI comprises at least one of a partially allowed NSSAI and a partially rejected NSSAI.

14. The network as claimed in claim 12, wherein the length of the at least one partial NSSAI of the configuration update command message being zero indicates that the at least one partial NSSAI does not include a single-NSSAI (S-NSSAI).
